(19) United States
(12) Patent Application Publication
(10) Pub. No.: US 2026/0271149 A1
(43) Pub. Date: Sep. 10, 2026

(54) Multi-Function Circuit with Multi-Function Pin and Method Thereof

(71) Applicant: RICHTEK TECHNOLOGY CORP., Hsinchu County (TW)

(72) Inventors: Ming-Hung Tsai, Hsinchu City (TW); Jyun-Che Ho, Hsinchu County (TW)

(21) Appl. No.: 19/324,214

(22) Filed: Sep. 10, 2025

Related U.S. Application Data
(60) Provisional application No. 63/769,163, filed on Mar. 10, 2025.

(51) Int. Cl. H05B 45/18; H02H 5/04; H05B 45/325; H05B 47/16

(52) U.S. Cl. CPC H05B 45/18; H02H 5/042; H05B 45/325; H05B 47/16

(57) ABSTRACT

A multi-function circuit uses a single multi-function pin to perform both light emitting diode (LED) driving and temperature sensing functions through time-division multiplexing. The circuit includes an LED driving circuit that provides a drive current to an LED during a first time period when the multi-function pin is configured as an output, and a temperature sensing circuit that generates a temperature-dependent voltage during a second time period when the multi-function pin is configured as an input. A voltage clamp circuit limits the maximum voltage at the multi-function pin to protect circuit components, particularly during transitions between operating modes. A sample and hold circuit samples and holds the temperature-dependent voltage as a holding voltage, making this information continuously available when the multi-function pin is being used to drive the LED.

### CROSS REFERENCE TO RELATED APPLICATIONS

This application claims the benefit of U.S. Provisional Application No. 63/769,163, filed on Mar. 10, 2025. The content of the application is incorporated herein by reference.

### BACKGROUND OF THE INVENTION

### 1. Field of the Invention

The present invention relates generally to integrated circuit design and electronic system architectures, and more particularly to a circuit for implementing multiple functions using a single multi-function pin.

### 2. Description of the Prior Art

Modern electronic devices continue to decrease in size while increasing in functionality. This trend has created significant challenges for integrated circuit designers who must balance the need for additional features against constraints on chip size, power consumption, and pin count. As portable devices such as smartphones, wearable technology, and IoT (Internet of Things) devices become increasingly compact, the number of available pins on integrated circuits has become a critical design limitation.

In typical integrated circuit applications, separate dedicated pins are allocated for distinct functions. For example, in applications requiring both LED (light emitting diode) control and temperature sensing, conventional designs utilize at least two separate pins: one pin dedicated to driving the LED and another pin dedicated to receiving temperature data from a temperature sensing element such as a thermistor. This approach, while straightforward to implement, results in higher pin counts and consequently larger package sizes, increased manufacturing costs, and greater board space requirements.

The use of separate pins for LED driving and temperature sensing functions presents particular challenges in space-constrained applications. LED indicators are commonly used in electronic devices to provide visual feedback to users, while temperature sensors are essential for thermal management to prevent overheating and ensure reliable operation. Both functions are frequently required in the same device, resulting in competing demands for limited pin resources.

Previous attempts to address pin limitations have included multiplexing techniques that share pins among digital functions. For example, U.S. Pat. No. 11,056,968 B2 describes using time-division multiplexing (TDM) methods for over-temperature protection (OTP) and over-voltage protection (OVP) detection. However, these prior solutions typically focus on sharing pins among similar types of functions (such as different sensing operations) rather than combining fundamentally different functions like output driving operations and input sensing operations on a single pin.

Furthermore, effectively multiplexing a pin between an output function like LED driving and an input function like temperature sensing presents significant technical challenges. These challenges include preventing signal conflicts, maintaining temperature measurement accuracy during LED operation, and ensuring proper LED brightness control while simultaneously monitoring temperature. Conventional approaches have not adequately addressed these challenges in an integrated, cost-effective solution.

Therefore, there exists a need for an improved circuit design that can efficiently utilize a single multi-function pin to perform both LED driving and temperature sensing functions without compromising performance in either mode of operation.

### SUMMARY OF THE INVENTION

An embodiment provides a multi-function circuit comprising a multi-function pin, an LED driving circuit, a temperature sensing circuit, a voltage clamp circuit, and a sample and hold circuit, each coupled to the multi-function pin. The multi-function pin is configured to provide an output for driving an LED during a first time period and to receive an input for sensing temperature via a thermistor during a second time period.

The LED driving circuit is configured to supply a drive current to the LED during the first time period and may further be configured to provide pulse-width modulated (PWM) signals to enable brightness control. The temperature sensing circuit is configured to generate a temperature-dependent voltage during the second time period, using a current source to supply sensing current to the thermistor, which may include a negative temperature coefficient (NTC) thermistor.

The voltage clamp circuit is configured to limit the maximum voltage at the multi-function pin. In one embodiment, the voltage clamp circuit includes a switch and an operational amplifier with a transistor output stage. In alternative embodiments, the voltage clamp circuit may include a plurality of MOSFETs configured to clamp voltage based on a threshold voltage, or a plurality of diodes configured to clamp voltage based on a diode forward voltage.

The sample and hold circuit is configured to sample and hold the temperature-dependent voltage as a holding voltage. It may include a capacitor, a switch controlled by a sample enable signal, and a buffer amplifier coupled to the capacitor. An analog-to-digital converter (ADC) may be coupled to the sample and hold circuit and configured to convert the holding voltage into a digital value for processing by associated systems.

In certain aspects, the multi-function circuit further includes a timing control circuit configured to generate non-overlapping control signals to alternate the configuration of the multi-function pin between the first and second time periods. The timing control circuit may be configured to generate a first control signal for the LED driving circuit, a second control signal for the temperature sensing circuit, a third control signal for the voltage clamp circuit, and a fourth control signal for the sample and hold circuit.

An embodiment provides a method for operating a single multi-function pin to perform multiple functions. The method includes configuring the pin to output a drive current to an LED during a first time period and to receive a sensing input during a second time period. During the second time period, a current source supplies a sensing current to a thermistor, and a temperature-dependent voltage is measured at the pin. The method further includes clamping the voltage at the pin, storing the measured voltage as a holding voltage, and converting it to a digital value for temperature determination.

Additional aspects may include comparing the temperature-dependent voltage to a threshold and triggering over-temperature protection if exceeded. In some embodiments, LED brightness is controlled via a pulse-width modulated (PWM) signal by adjusting its duty cycle. The method may also include dynamically adjusting the alternation frequency between time periods based on temperature sensing resolution. Measuring the temperature-dependent voltage may involve determining the resistance of an NTC thermistor.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a multi-function circuit with a single multi-function pin according to an embodiment.

FIG. 2 is a timing diagram illustrating the control signals and multi-function pin state during LED active drive phase operation according to an embodiment.

FIG. 3 is a timing diagram illustrating the control signals and multi-function pin state during LED inactive phase operation according to an embodiment.

FIG. 4 is a detailed schematic diagram of an implementation of the LED driving circuit in FIG. 1.

FIG. 5 is a detailed schematic diagram of an implementation of the temperature sensing circuit in FIG. 1.

FIG. 6 to FIG. 9 are schematic diagrams illustrating alternative implementations of the voltage clamp circuit in FIG. 1.

FIG. 10 is a flow diagram illustrating a method for operating a single multi-function pin for multiple functions.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

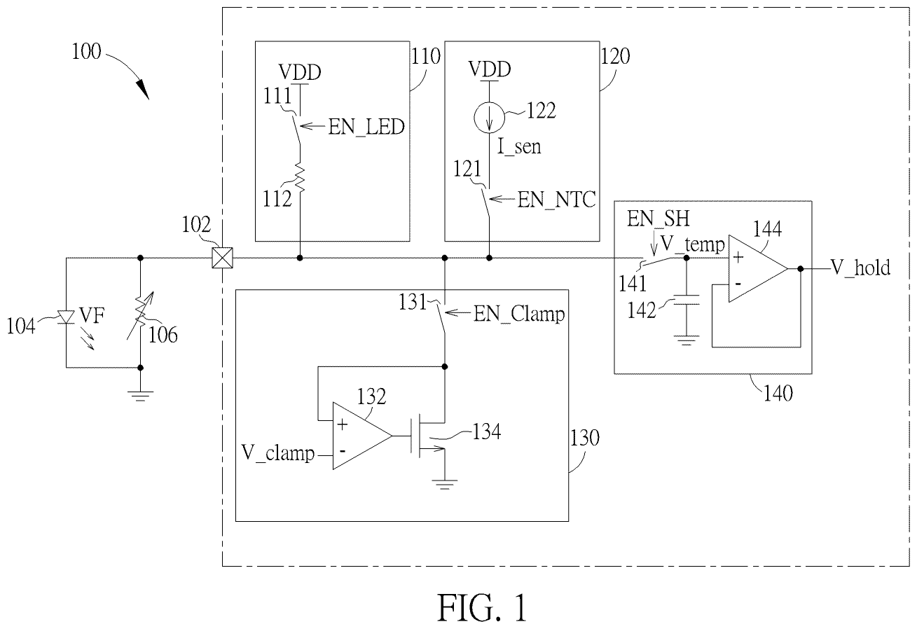

FIG. 1 is a schematic diagram illustrating a multi-function circuit 100 with a single multi-function pin 102 that alternately drives an LED and senses temperature according to an embodiment. The multi-function circuit 100 enables both LED driving during the first time period and temperature sensing during the second time period using a single multi-function pin 102. The circuit 100 includes an LED 104 and a thermistor 106 coupled to the multi-function pin 102. The thermistor 106 is a temperature-dependent resistor, typically a negative temperature coefficient (NTC) thermistor whose resistance decreases as temperature increases.

The multi-function circuit 100 comprises four main functional blocks: an LED driving circuit 110, a temperature sensing circuit 120, a voltage clamp circuit 130, and a sample and hold circuit 140. These functional blocks operate in a time-multiplexed manner to alternately drive the LED 104 and sense temperature through the thermistor 106 using the single multi-function pin 102.

The LED driving circuit 110 includes a switch 111 controlled by an LED enable signal EN_LED and a resistor 112. When the LED enable signal EN_LED is asserted, the switch 111 becomes conductive (turns on) to connect the multi-function pin 102 to the power supply voltage VDD, allowing current to flow through the LED 104.

The temperature sensing circuit 120 includes a switch 121 controlled by a temperature sensing enable signal EN_NTC and a current source 122 that provides a sensing current I_sen. When the temperature sensing enable signal EN_NTC signal is asserted, the switch 121 becomes conductive (turns on) to connect the current source 122 to the multi-function pin 102, causing the sensing current I_sen to flow through the thermistor 106. This generates a temperature-dependent voltage V_temp at the multi-function pin 102.

It should be noted that temperature-dependent voltage equals sensing current multiplied by the resistance of the thermistor 106, which can be expressed as:

$${V}_{temp} = {I}_{s e n} \times {R}_{N T C}$$

The equation Vₜₑₘₚ=Iₛₑₙ×R_{NTC} is fundamental to the temperature sensing operation of the circuit. It follows Ohm's Law, where voltage equals current multiplied by resistance. Since the current source 122 provides a precisely controlled sensing current I_sen (e.g., in the range of 20 μA to 100 μA), any variation in the measured voltage V_temp is directly proportional to changes in the thermistor resistance R_{NTC}. As temperature increases, the resistance of the NTC thermistor 106 decreases in a predictable and non-linear manner according to the thermistor's characteristics.

For example, a typical 100 kΩ NTC thermistor might have a resistance of approximately 100 kΩ at 25° C., decreasing to approximately 10 kΩ at 80° C. By measuring the voltage V_temp and knowing the precise value of I_sen, the circuit can accurately determine the resistance of the thermistor 106 and thereby calculate the temperature at the thermistor's location.

The voltage clamp circuit 130 includes a switch 131 controlled by a clamp enable signal EN_Clamp, an operational amplifier 132, and a transistor 134. The voltage clamp circuit 130 is configured to limit the maximum voltage at the multi-function pin 102 to a value less than the forward voltage VF of the LED 104 during the temperature sensing mode in the second time period. This voltage limiting prevents the LED 104 from being inadvertently illuminated during temperature sensing operations.

During the temperature sensing mode, when the thermistor 106 has high resistance at low temperatures, the temperature-dependent voltage Vtemp at the multi-function pin 102 can rise above the forward voltage VF of the LED 104 if no voltage clamp is present. This would cause the LED 104 to turn on unintentionally, creating an unwanted LED illumination state and interfering with proper circuit operation. The voltage clamp circuit 130 addresses this condition by maintaining the maximum voltage at the multi-function pin 102 below the forward voltage VF, ensuring that the LED 104 remains in its intended state (either intentionally on or intentionally off) regardless of the temperature-dependent voltage variations during the second time period. This voltage limiting function provides proper state control during temperature sensing operations, as LEDs have two distinct states—normally dark and normally bright—and the voltage clamp maintains appropriate state control during temperature sensing operations.

The sample and hold circuit 140 includes a switch 141 controlled by a sample enable signal EN_SH, a capacitor 142, and a buffer amplifier 144. During the second time period when the temperature sensing circuit 120 is active, the sample and hold circuit 140 samples and holds the temperature-dependent voltage V_temp on capacitor 142 when the sample enable signal EN_SH is asserted. Subsequently, during the first time period when the LED driving circuit 110 is active and the sample enable signal EN_SH is de-asserted, the buffer amplifier 144 holds this voltage as holding voltage V_hold with minimal voltage droop, allowing continuous access to the temperature information even when the multi-function pin 102 is being used to drive the LED 104.

During operation, the multi-function pin 102 alternates between two modes: LED driving mode during the first time period and temperature sensing mode during the second time period. These modes are controlled by non-overlapping timing signals to ensure that the LED driving circuit 110 and the temperature sensing circuit 120 are not simultaneously enabled, which would cause signal conflicts at the multi-function pin 102.

When the LED driving circuit 110 is active (EN_LED asserted), current flows from VDD through the switch 111, the resistor 112, the multi-function pin 102, and the LED 104 to the ground, causing the LED 104 to illuminate. During this period, the sample and hold circuit 140 maintains the previously sampled temperature value.

When the temperature sensing circuit 120 is active (EN_NTC asserted), the current source 122 supplies the sensing current I_sen through the thermistor 106, generating a voltage at the multi-function pin 102 that is proportional to the thermistor's resistance and therefore indicative of temperature. During this period, the sample and hold circuit 140 captures this voltage for subsequent processing and for use during the LED driving period.

The voltage clamp circuit 130 is activated during transitions to ensure voltage levels remain within safe operating ranges, particularly when switching from LED driving mode to temperature sensing mode. As indicated in the figure, the voltage clamp circuit 130 is engaged when switch 111 becomes non-conductive (turns off) and switch 131 becomes conductive (turns on) in response to the clamp enable signal EN_Clamp.

The operational amplifier 132 is configured with its non-inverting input terminal (positive terminal) receiving the reference voltage V_clamp and its inverting input terminal (negative terminal) connected to the output of the transistor 134. This non-inverting configuration establishes a negative feedback loop through transistor 134. During operation, if the voltage at the multi-function pin 102 attempts to rise above the reference voltage V_clamp, the operational amplifier 132 detects this deviation through its inverting input and increases its output voltage. This increased output drives the gate of transistor 134 more strongly, causing it to conduct more current and effectively pull down the multi-function pin voltage until it matches V_clamp. Conversely, if the multi-function pin voltage falls below V_clamp, the operational amplifier reduces the drive to transistor 134, allowing the multi-function pin voltage to rise. This continuous adjustment creates a regulation effect that maintains the multi-function pin voltage at approximately V_clamp. The voltage clamp circuit 130 is particularly active during transitions between the first time period (LED driving) and the second time period (temperature sensing), preventing voltage spikes that could otherwise damage circuit components or cause measurement errors. The reference voltage V_clamp can be selected to be less than the forward voltage of the LED 104 and still allowing proper temperature sensing.

The multi-function circuit 100 may further include an analog-to-digital converter (ADC) coupled to the sample and hold circuit 140, configured to convert the holding voltage V_hold to a digital value. The ADC receives the stable holding voltage V_hold from the buffer amplifier output of the sample and hold circuit 140 and performs quantization to generate a digital representation of the temperature information. In one embodiment, the ADC is implemented as a 10-bit successive approximation register (SAR) ADC, providing 1024 discrete levels for precise temperature resolution. The conversion begins when the holding voltage V_hold has stabilized during the first time period, allowing the ADC to operate without interference from switching transients at the multi-function pin. The digital output from the ADC can be further processed by a microcontroller or digital signal processor to calculate the actual temperature based on the known characteristics of the thermistor, typically using a lookup table or mathematical equation that relates the resistance of the thermistor to temperature.

The multi-function circuit 100 may further include a timing control circuit that generates and manages the non-overlapping control signals necessary for proper time-division multiplexing operation. This timing control circuit is a critical component that ensures the multi-function pin can alternate between output mode (LED driving) and input mode (temperature sensing) without signal conflicts or race conditions.

The timing control circuit generates four primary control signals: LED enable signal EN_LED, clamp enable signal EN_Clamp, temperature sensing enable signal EN_NTC, and sample enable signal EN_SH. Each of these signals must be precisely timed relative to one another to achieve proper operation of the multi-function circuit.

In one embodiment, the timing control circuit includes a clock generator, multiple counters, and logic elements to generate the non-overlapping control signals. The clock generator provides a base timing reference, typically operating at a frequency between 10 kHz and 1 MHz. This clock signal feeds into a digital state machine that sequences through multiple states to generate the four control signals with appropriate timing relationships.

For example, in a specific implementation, the timing control circuit may operate on a 20 kHz clock, dividing each complete cycle (LED driving plus temperature sensing) into 50 microsecond time slices. The state machine might allocate the time as follows: asserting EN_LED for 30 microseconds (first time period); de-assert EN_LED and assert EN_Clamp for 5 microseconds (non-overlapping period); assert EN_NTC and EN_SH for 10 microseconds (second time period); de-assert EN_NTC and EN_SH, maintaining EN_Clamp for 5 microseconds (non-overlapping period).

This timing sequence allows 60% of the cycle for LED driving and 20% for temperature sensing, with the remaining 20% allocated to non-overlapping periods that prevent signal conflicts at the multi-function pin. The timing control circuit ensures that these signals would not violate the non-overlapping requirement, even if process, voltage, or temperature variations affect the circuit's timing characteristics.

In another embodiment, the timing control circuit may adjust the duration of the first and second time periods dynamically based on application requirements. For instance, when more accurate temperature readings are needed, the circuit might extend the second time period (temperature sensing) to allow for longer integration time or averaging of multiple samples. Conversely, when higher LED brightness or more precise PWM control is required, the circuit might extend the first time period (LED driving) to allow for finer control of the duty cycle.

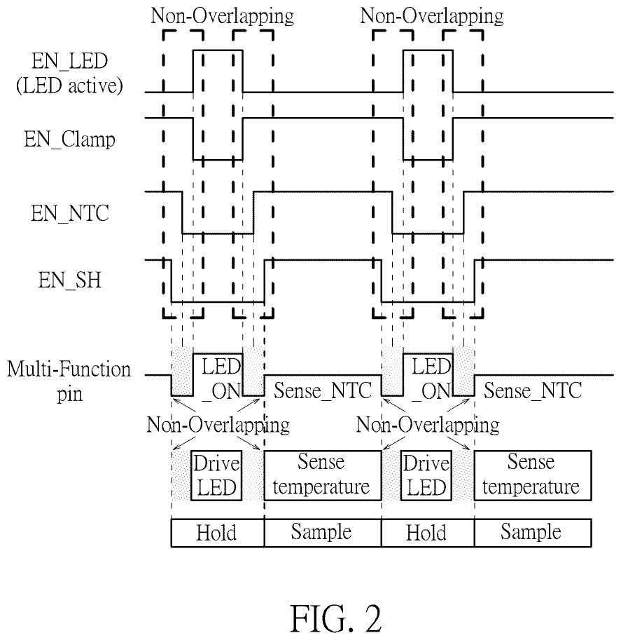

FIG. 2 is a timing diagram illustrating the control signals and multi-function pin state during LED active drive phase (PWM high state) operation according to an embodiment. This timing diagram illustrates the operation of the multi-function circuit when the LED is in an active drive phase (PWM high state). The diagram shows the temporal relationship between four control signals: LED enable signal EN_LED, clamp enable signal EN_Clamp, temperature sensing enable signal EN_NTC, and sample enable signal EN_SH. These signals control the operation of the LED driving circuit, voltage clamp circuit, temperature sensing circuit, and sample and hold circuit, respectively. The bottom portion of the diagram shows the resulting state of the multi-function pin and the active operating modes.

In FIG. 2, the timing diagram illustrates two complete cycles of operation. Each cycle includes a first time period (LED_ON) during which the multi-function pin is configured to provide an output to drive the LED, followed by a second time period (Sense_NTC) during which the multi-function pin is configured to receive an input to sense temperature. When the LED enable signal EN_LED is high during the first time period, the multi-function pin provides a drive current to the LED. When EN_NTC is high during the second time period, the multi-function pin is coupled to the current source to sense the temperature through the thermistor.

The timing diagram highlights “Non-Overlap” regions. These non-overlapping regions represent transitions between operating modes where the multi-function pin configuration changes. During the temperature sensing mode in the second time period, the clamp enable signal EN_Clamp is asserted to activate the voltage clamp circuit, which limits the voltage at the multi-function pin 102 to a value less than the forward voltage VF of the LED 104. This voltage limiting function prevents the LED 104 from being inadvertently illuminated during temperature sensing operations, as the temperature-dependent voltage Vtemp can exceed the forward voltage VF when the thermistor 106 has high resistance at low temperatures, which would otherwise cause unintended LED activation.

The sample enable signal EN_SH controls the sample and hold circuit and is timed to capture the temperature-dependent voltage during the temperature sensing period. As shown in the bottom row of the diagram, the sample and hold operation alternates between “Hold” during the LED driving period and “Sample” during the temperature sensing period. This arrangement allows the circuit to maintain the temperature information continuously, even when the multi-function pin is being used to drive the LED.

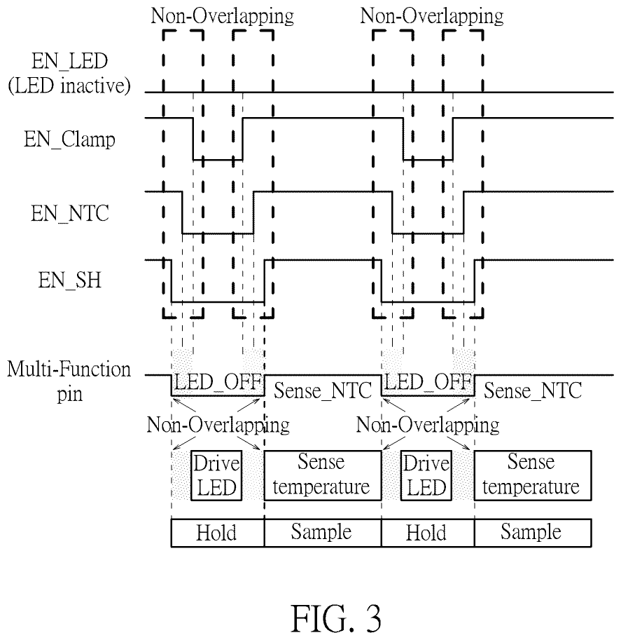

FIG. 3 is a timing diagram illustrating the control signals and multi-function pin state during LED inactive phase (PWM low state) operation according to an embodiment. This similar timing diagram illustrates the operation of the multi-function circuit when the LED is in an inactive phase (PWM low state). The key difference between FIG. 2 and FIG. 3 is the state of the EN_LED signal and the resulting state of the multi-function pin during the first time period.

In FIG. 3, the LED enable signal EN_LED remains low (LED inactive phase), indicating that the LED is not being driven during the first time period. However, the circuit still alternates between first time period (LED_OFF) and second time period (Sense_NTC) modes, maintaining the same timing structure with non-overlapping transitions. This demonstrates that the time-division multiplexing between the first and second time periods continues regardless of whether the LED is being actively driven, ensuring consistent temperature sensing intervals.

These timing diagrams (i.e., FIGS. 2 and 3) demonstrate how the circuit can incorporate pulse-width modulation (PWM) for LED brightness control while still performing temperature sensing. When implementing PWM, the LED enable signal EN_LED alternates between the patterns shown in FIG. 2 (for the active drive phase or PWM high portion of the cycle) and FIG. 3 (for the inactive phase or PWM low portion of the cycle), with the duty cycle determining the perceived brightness of the LED.

Both timing diagrams emphasize the critical non-overlapping regions during transitions between the first time period and the second time period, which prevent conflicts at the multi-function pin and ensure reliable operation. These non-overlapping periods are essential to the proper functioning of the multi-function circuit, as they provide sufficient time for the multi-function pin to stabilize when switching between output mode (providing a drive current to the LED during the first time period) and input mode (receiving a temperature-dependent voltage during the second time period).

The alternation between the first time period and the second time period across both FIG. 2 and FIG. 3 demonstrates the advantage of the invention: the ability to maintain regular temperature sensing intervals regardless of the LED's drive state (active or inactive), ensuring continuous temperature monitoring even during variable LED brightness control.

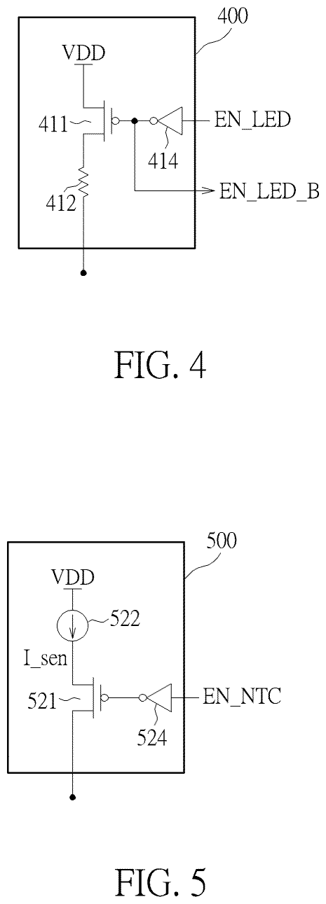

FIG. 4 is a detailed schematic diagram of an implementation of LED driving circuit of FIG. 1 according to an embodiment. An exemplary implementation of the LED driving circuit 400 (corresponding to LED driving circuit 110 in FIG. 1) is illustrated. The LED driving circuit 400 is configured to provide a drive current to the LED through the multi-function pin during the first time period.

The LED driving circuit 400 includes a switch 411 controlled by the LED enable signal EN_LED, a resistor 412, and a buffer 414. The switch 411 is coupled between the power supply voltage VDD and the resistor 412. When the LED enable signal EN_LED is asserted (high), the switch 411 becomes conductive (turns on), connecting the resistor 412 to power supply voltage VDD. This allows current to flow from the power supply voltage VDD through the switch 411, the resistor 412, and out to the multi-function pin to drive the LED during the first time period.

The buffer 414 receives the LED enable signal EN_LED and generates a complementary signal EN_LED_B, which is used for timing control purposes in other parts of the circuit, particularly for generating non-overlapping signals. This complementary signal EN_LED_B transitions in the opposite direction from LED enable signal EN_LED: when EN_LED goes high, EN_LED_B goes low, and vice versa. The precise timing of these complementary signals is critical for ensuring non-overlapping operation.

The resistor 412 serves to limit the current flowing to the LED, determining the LED brightness when it is in the active drive phase. The value of resistor 412 is selected based on the desired LED current and the forward voltage VF of the LED. In one embodiment, resistor 412 may have a value between 1000 and 1 kΩ, depending on the specific LED characteristics and brightness requirements.

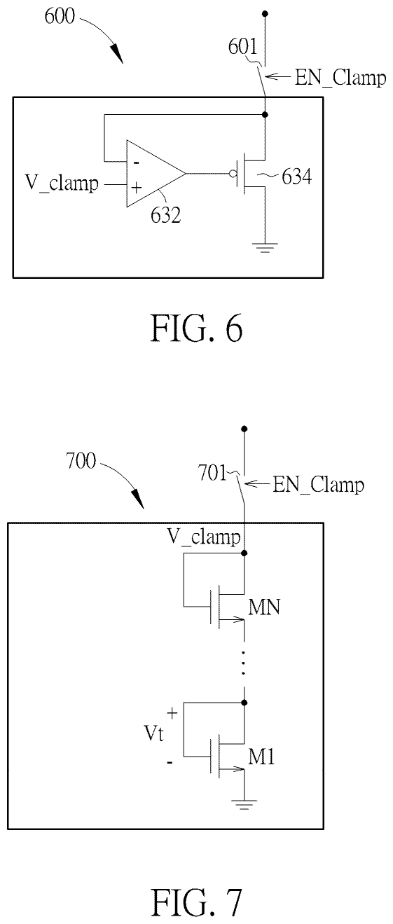

FIG. 5 is a detailed schematic diagram of an implementation temperature sensing circuit of FIG. 1 according to an embodiment. A detailed implementation of the temperature sensing circuit 500 (corresponding to the temperature sensing circuit 120 in FIG. 1) is illustrated. The temperature sensing circuit 500 is configured to generate a temperature-dependent voltage at the multi-function pin during the second time period.

The temperature sensing circuit 500 includes a current source 522, a switch 521 controlled by the temperature sensing enable signal EN_NTC, and a buffer 524. The current source 522 is coupled to the power supply voltage VDD and is designed to provide a sensing current I_sen. When the temperature sensing enable signal EN_NTC is asserted (high), the switch 521 becomes conductive (turns on), connecting the current source 522 to the multi-function pin. This allows the sensing current I_sen to flow through the thermistor coupled to the multi-function pin, generating a voltage that is proportional to the thermistor's resistance and therefore indicative of temperature.

The buffer 524 receives the temperature sensing enable signal EN_NTC and may be used for signal conditioning or for generating control signals used elsewhere in the circuit. In some embodiments, buffer 524 may generate a complementary signal that could be used in coordination with EN_LED_B for generating non-overlapping control signals.

An aspect of the multi-function circuit operation is ensuring that the LED driving circuit 400 and the temperature sensing circuit 500 do not simultaneously connected to the multi-function pin, which would cause signal conflicts or undefined states. This can be achieved through the careful generation of non-overlapping control signals EN_LED and EN_NTC.

The non-overlapping characteristic is implemented by ensuring that when LED driving enable signal EN_LED transitions from high to low, there is a downtime before the temperature sensing enable signal EN_NTC transitions from low to high, and vice versa. The downtime, typically in the range of microseconds, provides a safety margin during which neither circuit is actively connected to the multi-function pin, allowing for clean transitions between operating modes.

In one implementation, complementary signal EN_LED_B can feed into a delay element whose output contributes to the generation of the temperature sensing enable signal EN_NTC. Similarly, a complementary signal derived from temperature sensing enable signal EN_NTC may feedback into a delay element that affects the generation of LED driving enable signal EN_LED. This cross-coupling with appropriate delays ensures that: when EN_LED goes low, EN_LED_B goes high immediately; the rising edge of EN_LED_B, after passing through a delay element, enables the assertion of EN_NTC; when EN_NTC goes low, its complementary signal goes high immediately, the rising edge of this complementary signal, after passing through another delay element, enables the assertion of EN_LED.

Such arrangement ensures that the control signals EN_LED and EN_NTC cannot both be high simultaneously, which enforces the time-division multiplexing necessary for the multi-function pin to perform both functions without conflict. It also ensure proper operation of the voltage clamp circuit and sample and hold circuit by controlling when the clamp enable signal EN_Clamp and sample enable signal EN_SH signals are asserted relative to the LED driving enable signal EN_LED and temperature sensing enable signal EN_NTC.

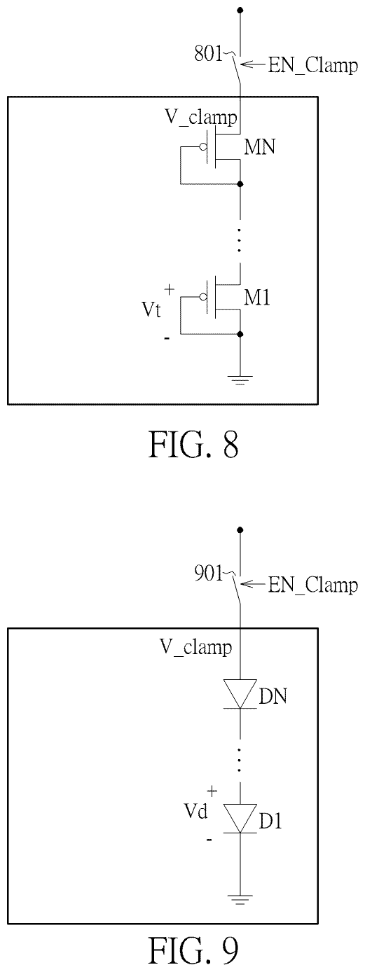

FIG. 6 is a schematic diagram illustrating an implementation of a voltage clamp circuit according to an embodiment. The voltage clamp circuit 600 is an alternative implementation of the voltage clamp circuit 130 in FIG. 1. The voltage clamp circuit 600 is configured to limit the maximum voltage at the multi-function pin to a value less than the forward voltage of the LED, particularly during transitions between the first time period and the second time period.

The voltage clamp circuit 600 includes a switch 601 controlled by the clamp enable signal EN_Clamp, an operational amplifier 632, and a transistor 634. When the clamp enable signal EN_Clamp is asserted, the switch 601 becomes conductive (turns on), activating the voltage clamp circuit 600. When clamp enable signal EN_Clamp is de-asserted, switch 601 becomes non-conductive (turns off), deactivating the voltage clamp circuit 600. The operational amplifier 632 is configured in an inverting configuration, which differs from the implementation shown in FIG. 1.

The operational amplifier 632 is configured with its inverting input terminal (negative input) receiving the reference voltage V_clamp and its non-inverting input terminal (positive input) coupled to the output of the transistor 634. The output of the operational amplifier 632 drives the gate of the transistor 634. This inverting arrangement creates a different control dynamic compared to the non-inverting configuration in FIG. 1.

In this configuration, when the voltage at the multi-function pin rises above the reference level, the positive input of the operational amplifier 632 exceeds the negative input, causing the operational amplifier output to rise. This increases the gate drive to the transistor 634, turning it on more strongly and pulling the multi-function pin voltage down. As the multi-function pin voltage falls, the positive input of the operational amplifier falls accordingly, creating a negative feedback loop that stabilizes when the multi-function pin voltage matches the reference voltage V_clamp.

This inverting implementation provides an alternative approach to voltage clamping that may offer advantages in certain applications. The reference voltage Vclamp can be selected to be less than the forward voltage of the LED, for example, around 80% of forward voltage VF of the LED. This voltage level ensures that when the voltage clamp circuit 130 is activated, the LED 104 remains inactivated (dark state), preventing inadvertent LED illumination during temperature sensing operations when the temperature-dependent voltage Vtemp could otherwise exceed the LED's forward voltage VF.

FIG. 7 is a schematic diagram illustrating an alternative implementation of a voltage clamp circuit according to an embodiment. The voltage clamp circuit 700 uses a different approach to voltage clamping, employing a stack of MOSFETs instead of an operational amplifier configuration.

The voltage clamp circuit 700 includes a switch 701 controlled by the clamp enable signal EN_Clamp and a series of MOSFETs (M1 through MN) arranged in a stack. Switch 701 functions as the activation control for the MOSFET-based voltage clamp. When the clamp enable signal EN_Clamp is asserted, the switch 701 becomes conductive (turns on), connecting the MOSFET stack to the multi-function pin and enabling its voltage clamping function. When clamp enable signal EN_Clamp is de-asserted, switch 701 becomes non-conductive (turns off), disconnecting the MOSFET stack from the multi-function pin to prevent unwanted loading or interference during regular operation phases.

Each MOSFET in the stack (M1 through MN) has a characteristic threshold voltage Vt. When configured as shown, with gates connected to drains for each transistor, each MOSFET acts as a diode with a voltage drop approximately equal to its threshold voltage. With N transistors in series, the total voltage drop becomes Vt×N, which establishes the clamping voltage V_clamp.

The clamping action occurs when the voltage at the multi-function pin attempts to rise above V_clamp (equal to Vt×N). At this point, the MOSFET stack begins to conduct current, effectively preventing the multi-function pin voltage from exceeding V_clamp. This maintains the condition where V_clamp is less than the forward voltage of the LED, providing the necessary protection.

The number of MOSFETs in the stack can be adjusted to achieve the desired clamping voltage. For example, if each MOSFET has a threshold voltage of approximately 0.6V, a stack of three MOSFETs can create a clamping voltage of about 1.8V, which would be appropriate for LEDs with forward voltages in the 2.0-2.5V range.

FIG. 8 is a schematic diagram illustrating an alternative implementation of a voltage clamp circuit using a MOSFET stack according to an embodiment. The voltage clamp circuit 800 employs a stack of multiple MOSFETs to achieve voltage clamping functionality.

The voltage clamp circuit 800 includes a switch 801 controlled by the clamp enable signal EN_Clamp and a series of MOSFETs (M1 through MN) arranged in a stack configuration. Switch 801 functions as the activation control for the MOSFET-based voltage clamp. When the clamp enable signal EN_Clamp is asserted, the switch 801 becomes conductive (turns on), connecting the MOSFET stack to the multi-function pin and enabling its voltage clamping function. When the clamp enable signal EN_Clamp is de-asserted, switch 801 becomes non-conductive (turns off), disconnecting the MOSFET stack from the multi-function pin to prevent unwanted loading or interference during regular operation phases.

The MOSFET stack creates a voltage clamp by utilizing the threshold voltages of the individual transistors. Each MOSFET in the stack (M1 through MN) has a characteristic threshold voltage. When configured with gates connected to drains in a diode-connected arrangement, each MOSFET acts as a voltage-controlled device with a voltage drop approximately equal to its threshold voltage. With N transistors in series, the total voltage drop becomes Vt×N, which establishes the clamping voltage V_clamp.

The clamping action occurs when the voltage at the multi-function pin attempts to rise above V_clamp (equal to Vt×N). At this point, the MOSFET stack begins to conduct current, effectively preventing the multi-function pin voltage from exceeding V_clamp. This maintains the condition where V_clamp is less than the forward voltage of the LED, providing the necessary protection during transitions between operating modes.

It is important to note the difference between the MOSFET stack implementations voltage clamp circuits 700 and 800. The voltage clamp circuit 700 employs NMOS (N-channel Metal Oxide Semiconductor) transistors, while the voltage clamp circuit 800 employs PMOS (P-channel Metal Oxide Semiconductor) transistors. This distinction affects both the polarity and operation of the voltage clamp. NMOS transistors conduct when a positive gate-to-source voltage exceeds the threshold voltage, making the FIG. 7 implementation suitable for pulling the multi-function pin voltage down toward ground. In contrast, PMOS transistors conduct when the gate-to-source voltage becomes sufficiently negative compared to the threshold voltage. The choice between NMOS and PMOS implementations depends on factors such as the expected voltage range at the multi-function pin, available semiconductor process, and specific circuit requirements.

FIG. 9 is a schematic diagram illustrating an alternative implementation of a voltage clamp circuit using a diode stack according to an embodiment. The voltage clamp circuit 900 employs a stack of diodes instead of MOSFETs or an operational amplifier configuration.

The voltage clamp circuit 900 includes a switch 901 controlled by the clamp enable signal EN_Clamp and a series of diodes (D1 through DN) arranged in a stack. Switch 901 serves as the activation control for the diode-based voltage clamp. When the clamp enable signal EN_Clamp is asserted, the switch 901 becomes conductive (turns on), connecting the diode stack to the multi-function pin and enabling its voltage clamping function. When the clamp enable signal EN_Clamp is de-asserted, switch 901 becomes non-conductive (turns off), disconnecting the diode stack from the multi-function pin.

The diode stack creates a voltage clamp using the forward voltage drops of the individual diodes. Each diode in the stack (D1 through DN) has a characteristic forward voltage drop Vd. With N diodes in series, the total voltage drop becomes Vd×N, which establishes the clamping voltage V_clamp.

The clamping action occurs when the voltage at the multi-function pin attempts to rise above V_clamp (equal to Vd×N). At this point, the diode stack begins to conduct current, effectively preventing the multi-function pin voltage from exceeding V_clamp. This maintains the condition where V_clamp is less than the forward voltage of the LED, providing the necessary protection.

The number of diodes (N) in the stack can be adjusted to achieve the desired clamping voltage. For example, if standard silicon diodes with forward voltages of approximately 0.7V are used, a stack of three diodes would create a clamping voltage of about 2.1V.

The alternative voltage clamp circuit implementations (shown in FIG. 6, FIG. 7, FIG. 8, and FIG. 9) each provide different approaches to achieving the same fundamental function: limiting the voltage at the multi-function pin to a value less than the forward voltage of the LED during transitions between operating modes. The choice between these implementations depends on specific application requirements. Each implementation can be selected based on factors such as power constraints, available semiconductor process technology, cost considerations, voltage range requirements, and the precision required for the clamping voltage in the specific application. The availability of complementary NMOS and PMOS options provides flexibility for designers to choose the most appropriate solution for their particular voltage clamping needs.

The various switches utilized throughout the multi-function circuit (e.g., switches 111, 121, 131, 141, 411, 521, 601, 701, 801, and 901) may be implemented using semiconductor devices, such as MOSFETs, which are suited for integration in modern semiconductor processes. In one embodiment, these switches are implemented using N-channel MOSFETs (NMOS), where the control signals (EN_LED, EN_NTC, EN_Clamp, and EN_SH) are connected to the gate terminals. When a control signal is asserted (high), the corresponding NMOS transistor becomes conductive, creating a low-resistance path between its source and drain terminals. When the control signal is de-asserted (low), the NMOS transistor becomes non-conductive, effectively opening the circuit path. For switches requiring bidirectional current flow or reduced voltage drop, complementary MOS (CMOS) transmission gates may be employed, comprising parallel NMOS and PMOS transistors with complementary gate control signals. The CMOS implementation provides low on-resistance across a wide voltage range and minimizes signal degradation. Switch sizing is optimized based on the specific current and voltage requirements of each circuit section, with switches in the LED driving path typically dimensioned larger to handle higher currents. Switches in the sensing path are optimized for minimal leakage and parasitic capacitance to maintain measurement accuracy.

It should be understood that additional circuit configurations utilizing other semiconductor devices, different component arrangements, or hybrid approaches combining aspects of multiple implementations may be employed to achieve the voltage clamping function required by the multi-function circuit. For instance, the voltage clamp circuit may incorporate Zener diodes to establish precise voltage thresholds, Schottky diodes for low voltage drop applications, or bidirectional transient voltage suppressor (TVS) diodes for enhanced protection against voltage transients. Alternative semiconductor technologies such as gallium arsenide (GaAs) or silicon carbide (SiC) devices may be employed in high-frequency or high-temperature applications where conventional silicon-based implementations may be insufficient. The voltage clamp circuit may also utilize active components such as voltage regulators, bandgap reference circuits, or precision voltage sources to generate the reference voltage Vclamp, providing enhanced accuracy and temperature stability compared to passive implementations. In certain embodiments, programmable voltage clamp circuits may be implemented using digital-to-analog converters (DACs) or programmable voltage references, allowing dynamic adjustment of the clamping voltage based on system requirements or LED characteristics. Hybrid implementations may combine multiple voltage clamping techniques, such as primary clamping through MOSFET stacks with secondary protection via Zener diodes, providing redundant protection mechanisms. The specific choice of voltage clamp implementation depends on factors including voltage accuracy requirements, power consumption constraints, temperature operating range, manufacturing cost considerations, and integration compatibility with the overall semiconductor process technology employed for the multi-function circuit.

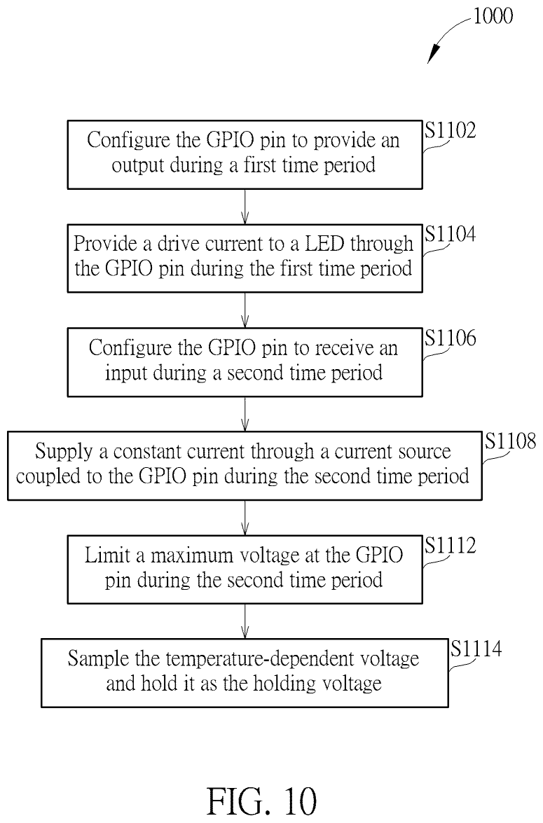

FIG. 10 is a flow diagram illustrating a method 1000 for operating a single multi-function pin in multi-function circuit 100. The method 1000 includes the following steps:
S1102: Configure the multi-function pin 102 to provide an output during a first time period;
S1104: Provide a drive current to a LED 104 through the multi-function pin 102 during the first time period;
S1106: Configure the multi-function pin 102 to receive an input during a second time period;
S1108: Supply a sensing current I_sen through a current source 122 coupled to the multi-function pin 102 during the second time period;
S1110: Measuring a temperature-dependent voltage V_temp at the multi-function pin 102 during the second time period;
S1112: Limit a maximum voltage V_clamp at the multi-function pin 102 during the second time period; and
S1114: Sample the temperature-dependent voltage V_temp and hold it as a holding voltage V_hold.

In step S1102, the multi-function pin 102 is configured to operate in output mode during the first time period. This configuration involves setting appropriate control registers in the associated microcontroller or integrated circuit to establish the multi-function pin 102 as an output driver. The timing control circuit asserts the LED enable signal EN_LED, which activates the switch in the LED driving circuit 110. Simultaneously, the timing control circuit ensures that the temperature sensing enable signal EN_NTC is de-asserted to prevent the temperature sensing circuit 120 from connecting to the multi-function pin 102 during this period. This configuration prepares the multi-function pin 102 to source current for driving the LED 104.

In step S1104, once the multi-function pin 102 is properly configured as an output, a drive current is provided to the LED 104 through the multi-function pin 102. When the LED enable signal EN_LED is asserted, the switch in the LED driving circuit 110 becomes conductive, connecting the power supply voltage VDD to the multi-function pin 102. This creates a current path from the power supply voltage VDD through the LED driving circuit 110, the multi-function pin 102, and the LED 104 to ground. The magnitude of the drive current is determined by the components in the LED driving circuit 110 and the forward voltage VF of the LED 104. In PWM applications, this step may be repeatedly executed with varying duty cycles to control the perceived brightness of the LED 104.

In step S1106, following the first time period, the multi-function pin 102 is reconfigured to operate in input mode during the second time period. This transition occurs with precise timing to avoid conflicts. First, the LED enable signal EN_LED is de-asserted, disconnecting the LED driving circuit 110 from the multi-function pin 102. After a non-overlapping period to ensure the LED driving circuit 110 is fully disconnected, the multi-function pin 102 is configured as an input by setting the appropriate control registers. The temperature sensing enable signal EN_NTC is then asserted to enable the temperature sensing circuit 120. During this configuration transition, the timing control circuit ensures that both the LED driving circuit 110 and temperature sensing circuit 120 are not simultaneously connected to the multi-function pin 102.

In step S1108, once the multi-function pin 102 is configured as an input, a sensing current I_sen is supplied through the current source in the temperature sensing circuit 120 to the multi-function pin 102. When the temperature sensing enable signal EN_NTC is asserted, the switch in the temperature sensing circuit 120 becomes conductive, connecting the current source to the multi-function pin 102. This sensing current I_sen flows through the thermistor 106, which is connected between the multi-function pin 102 and ground. The current source can be precisely calibrated to provide a known current (e.g., in the range of 10 μA to 100 μA) that remains stable regardless of the thermistor's resistance variations due to temperature changes.

In step S1110, the temperature-dependent voltage V_temp is measured at the multi-function pin 102 during the second time period. As the sensing current I_sen flows through the thermistor 106, a voltage develops across the thermistor according to Ohm's Law: Vₜₑₘₚ=Iₛₑₙ×R_{NTC}, where R_{NTC} is the resistance of the thermistor 106. Since the thermistor 106 exhibits a well-defined relationship between resistance and temperature (typically with a negative temperature coefficient where resistance decreases as temperature increases), the voltage V_temp provides a direct indication of temperature. This voltage may be measured through internal connections to an analog-to-digital converter via the sample and hold circuit 140.

In step S1112, the maximum voltage at the multi-function pin 102 is limited to clamping voltage V_clamp during the second time period to protect the circuit and ensure proper operation. The clamp enable signal EN_Clamp is asserted, activating the voltage clamp circuit 130 by making its switch conductive. The voltage clamp circuit 130 prevents the voltage at the multi-function pin 102 from exceeding V_clamp, which is designed to be less than the forward voltage VF of the LED 104.

In step S1114, the temperature-dependent voltage V_temp is sampled and held as a holding voltage V_hold. When the sample enable signal EN_SH is asserted, the switch in the sample and hold circuit 140 becomes conductive, allowing the temperature-dependent voltage V_temp to charge the capacitor in the sample and hold circuit 140. During this sampling phase (second time period), the voltage across the capacitor closely follows temperature-dependent voltage V_temp. When the sample enable signal EN_SH is subsequently de-asserted, the switch becomes non-conductive, isolating the capacitor. The buffer amplifier 144 in the sample and hold circuit 140 reads this capacitor voltage and produces a stable holding voltage V_hold at its output. The holding voltage V_hold at the output of the buffer amplifier 144 remains available during the first time period, allowing continuous access to the temperature information even when the multi-function pin 102 returns to driving the LED 104.

In certain implementations, the method 1000 further comprises processing temperature information after step S1114. This processing includes converting the holding voltage V_hold to a digital value using an ADC coupled to the sample and hold circuit 140. Once digitized, the temperature can be determined based on the digital value by applying a known relationship between the thermistor resistance and temperature. This relationship is typically non-linear and may be implemented as a lookup table or a mathematical equation in a microcontroller or digital signal processor. The conversion from voltage to temperature may account for calibration factors specific to the thermistor 106 characteristics and the precise value of the sensing current I_sen. This digital temperature value can then be used for thermal management, display purposes, or to trigger protection mechanisms in the system.

In certain implementations, thermal protection functionality is incorporated. After measuring the temperature-dependent voltage V_temp in step S1110, the temperature-dependent voltage V_temp can be compared to a threshold voltage that represents an over-temperature condition. When the temperature-dependent voltage V_temp exceeds this threshold voltage (or falls below it, depending on the thermistor type), an over-temperature protection operation can be triggered. This protection operation may include reducing power to heat-generating components, activating cooling systems, generating an alert signal, or in critical situations, shutting down portions of the circuit system to prevent damage.

In certain implementations, the step S1104 of providing the drive current to the LED 104 includes operations to enable brightness control. The PWM signal can be generated, causing the LED driving circuit 110 to alternately connect and disconnect the power supply voltage VDD to the multi-function pin 102 according to the PWM pattern. The brightness of the LED 104 can be controlled by adjusting a duty cycle of the pulse-width modulated signal, where a higher duty cycle produces greater perceived brightness and a lower duty cycle reduces brightness.

The method 1000 can operate in a continuous cycle, alternating between the first time period and the second time period. The timing control circuit manages the precise timing of all control signals (LED enable signal EN_LED, temperature sensing enable signal EN_NTC, clamp enable signal EN_Clamp, and sample enable signal EN_SH) to manage proper sequencing and non-overlapping operation. This cyclical operation can enable the single multi-function pin 102 to perform both LED driving and temperature sensing functions in a time-division multiplexed manner, effectively reducing the pin count required for these functions while maintaining full functionality.

The multi-function circuit and associated methods disclosed herein provide several technical advances. By utilizing time-division multiplexing to enable a single multi-function pin to perform both LED driving and temperature sensing functions, the invention reduces the required pin count. This pin count reduction translates directly to smaller package sizes, reduced manufacturing costs, and decreased board space requirements, making the invention particularly suitable for space-constrained applications such as wearable devices, portable electronics, and Internet of Things systems. The invention maintains full functionality of both LED control and temperature monitoring without compromising performance in either mode, achieving measurement accuracy comparable to dedicated pin implementations while adding the capability for PWM-based LED brightness control. The voltage clamp circuit provides reliable operation by preventing inadvertent LED activation during temperature sensing, and the sample and hold circuit enables continuous temperature monitoring even during LED driving periods. The non-overlapping timing control prevents signal conflicts and ensures stable operation across varying process, voltage, and temperature conditions. Additionally, the modular architecture allows for implementation flexibility, with multiple voltage clamp circuit options and the ability to dynamically adjust timing parameters based on application requirements. These enable system designers to achieve enhanced functionality within existing pin budgets, supporting the ongoing trend toward increased integration and miniaturization in modern electronic systems.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

In various embodiments, the multi-function pin may be implemented using different types of configurable input/output interfaces commonly found in integrated circuits and microcontroller systems. For example, the multi-function pin may be implemented as a general purpose input/output (GPIO) pin that can be programmatically configured to function as either an input or an outputs. In other implementations, the multi-function pin may be realized using programmable I/O pins, configurable I/O cells, bidirectional interface pins, or any other suitable pin structure capable of being dynamically reconfigured between output mode for driving an external component and input mode for receiving signals from external components.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain embodiments, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-function circuit comprising:
a multi-function pin configured to provide an output to drive an LED during a first time period and to receive an input to sense temperature via a thermistor during a second time period;
an LED driving circuit coupled to the multi-function pin, configured to provide a drive current to the LED during the first time period;
a temperature sensing circuit coupled to the multi-function pin, configured to generate a temperature-dependent voltage during the second time period;
a voltage clamp circuit coupled to the multi-function pin, configured to limit a maximum voltage at the multi-function pin; and
a sample and hold circuit coupled to the multi-function pin, configured to sample and hold the temperature-dependent voltage as a holding voltage.

2. The multi-function circuit of claim 1, further comprising a timing control circuit configured to generate non-overlapping control signals to alternate the configuration of the multi-function pin between the first time period and the second time period.

3. The multi-function circuit of claim 2, wherein the timing control circuit is configured to generate:
a first control signal for controlling the LED driving circuit during the first time period;
a second control signal for controlling the temperature sensing circuit during the second time period;
a third control signal for controlling the voltage clamp circuit; and
a fourth control signal for controlling the sample and hold circuit.

4. The multi-function circuit of claim 1, wherein the LED driving circuit comprises:
a first switch coupled to the multi-function pin, configured to be conductive and receive a power supply voltage during the first time period; and
a first resistor coupled between the first switch and the multi-function pin.

5. The multi-function circuit of claim 1, wherein the temperature sensing circuit comprises:
a second switch coupled to the multi-function pin; and
a current source coupled to the second switch, configured to supply a sensing current to the thermistor based on a power supply voltage during the second time period.

6. The multi-function circuit of claim 1, wherein the voltage clamp circuit comprises:
a third switch coupled to the multi-function pin; and
an operational amplifier with a transistor output stage coupled to the third switch.

7. The multi-function circuit of claim 1, wherein the voltage clamp circuit comprises:
a plurality of MOSFETs configured to limit the maximum voltage based on a threshold voltage; or
a plurality of diodes configured to limit the maximum voltage based on a diode forward voltage.

8. The multi-function circuit of claim 1, wherein the sample and hold circuit comprises:
a capacitor;
a fourth switch coupled to the capacitor, controlled by a sample enable signal; and
a buffer amplifier coupled to the fourth switch and the capacitor, configured to hold the temperature-dependent voltage as the holding voltage during the first time period.

9. The multi-function circuit of claim 1, wherein the thermistor comprises a negative temperature coefficient (NTC) thermistor.

10. The multi-function circuit of claim 1, further comprising an analog-to-digital converter (ADC) coupled to the sample and hold circuit, configured to convert the holding voltage to a digital value.

11. The multi-function circuit of claim 1, wherein the LED driving circuit is further configured to provide pulse-width modulated (PWM) signals to the LED through the multi-function pin during the first time period.

12. The multi-function circuit of claim 1, wherein the voltage clamp circuit is configured maintain the maximum voltage at the multi-function pin below a forward voltage of the LED.

13. A method of operating a single multi-function pin for multiple functions, comprising:
configuring the multi-function pin to provide an output during a first time period;
providing a drive current to a light emitting diode (LED) through the multi-function pin during the first time period;
configuring the multi-function pin to receive an input during a second time period;
supplying a sensing current through a current source coupled to the multi-function pin during the second time period;
measuring a temperature-dependent voltage at the multi-function pin during the second time period;
limiting a maximum voltage at the multi-function pin during the second time period; and
sampling and holding the temperature-dependent voltage as a holding voltage.

14. The method of claim 13, wherein the second time period does not overlap with the first time period.

15. The method of claim 13, further comprising generating non-overlapping control signals to alternate between the first time period and the second time period.

16. The method of claim 13, wherein limiting the maximum voltage at the multi-function pin comprises activating a voltage clamp circuit when transitioning from the first time period to the second time period.

17. The method of claim 13, wherein storing the temperature-dependent voltage comprises:
activating a switch to capture the temperature-dependent voltage on a capacitor during the second time period; and
buffering the captured voltage with a buffer amplifier to maintain the temperature-dependent voltage during the first time period.

18. The method of claim 13, further comprising:
converting the holding voltage to a digital value; and
determining a temperature based on the digital value.

19. The method of claim 13, further comprising:
comparing the temperature-dependent voltage to a threshold voltage; and
implementing an over-temperature protection operation when the temperature-dependent voltage exceeds the threshold voltage.

20. The method of claim 13, wherein providing the drive current to the LED comprises:
generating a pulse-width modulated (PWM) signal; and
controlling brightness of the LED by adjusting a duty cycle of the pulse-width modulated signal.
